(19) United States
(12) Patent Application Publication
(10) Pub. No.: US 2011/0220264 A1
(43) Pub. Date: Sep. 15, 2011

(54) PNEUMATIC TIRE AND METHOD OF MANUFACTURING OF THE SAME

(75) Inventor: Kunihiko Nagai, Osaka (JP)

(73) Assignee: TOYO TIRE & RUBBER CO., LTD., Osaka (JP)

(21) Appl. No.: 13/041,504

(22) Filed: Mar. 7, 2011

(30) Foreign Application Priority Data
Mar. 12, 2010 (JP) 2010-056237

(51) Int. Cl. B60C 9/02; B29D 30/08

(52) U.S. Cl. 152/548; 156/123

(57) ABSTRACT

A pneumatic tire has a plurality of projections extending in a tire width direction while protruding out of an inner surface of a tire. The projections are formed in a region coming to an inner side in a tire width direction than an end portion of a belt layer embedded in a tread portion so as to be spaced in a tire circumferential direction.

### BACKGROUND OF THE INVENTION

1. Field of the Invention

The present invention relates to a pneumatic tire which can reduce a road noise caused by a cavity resonance, and a method of manufacturing the same.

2. Description of the Related Art

When a vehicle travels on a rough road surface or climbs over a joint of the road surface, a noise called as a road noise may be generated in a car interior. This road noise is one of the noises involved in a tire, and when the tire is excited by an input of a concavity and convexity of the road surface to the tire, the vibration is transmitted to a vehicle body through an axle or a suspension, and the noise is generated in the car interior finally. It has been known that the cavity resonance of a tire is concerned in the noise which is generated in the vicinity of 250 Hz in the car interior noise.

In order to reduce the road noise caused by the cavity resonance mentioned above, Japanese Unexamined Patent Publication No. 2003-226104 describes a pneumatic tire in which an object having a cross sectional area changed in correspondence to a position in a tire circumferential direction is installed to an inner surface of a tread portion by a ring-like jig made of an elastic body. However, since the tread portion is bent each time when it is grounded on the road surface so as to constantly repeat a deformation, there is a risk that the material body falls off during the travel in this structure. Further, there is such a problem that a complicated step for attaching the object to the tire is necessary.

Japanese Unexamined Patent Publication No. 2002-120509 describes a pneumatic tire provided with a shape change in a range from a bead toe to a tire maximum width position of a tire inner surface, in such a manner that a cross sectional area of a cavity portion changes in a tire circumferential direction. However, if the tire inner surface is protruded in the vicinity of the tire maximum width position, an increase of a vertical rigidity of the tire is caused, therefore there is a tendency that a ride comfort performance is deteriorated. Further, in tires described in Japanese Unexamined Patent Publications No. 2007-276712, 2007-302072 and 2006-248318, a projection is provided in a tire inner surface of a buttress portion or a side wall portion, and there is fear that the ride comfort performance is deteriorated.

### SUMMARY OF THE INVENTION

The present invention is made by taking the actual condition mentioned above into consideration, and a purpose of the present invention is to provide a pneumatic tire which can reduce a road noise caused by a cavity resonance without deteriorating a ride comfort performance, and a method of manufacturing the same.

The purpose can be achieved by the following present invention. That is, the present invention provides a pneumatic tire wherein a plurality of projections extending in a tire width direction while protruding out of an inner surface of a tire are formed in a region coming to an inner side in a tire width direction than an end portion of a belt layer embedded in a tread portion so as to be spaced in a tire circumferential direction.

In the pneumatic tire, since a plurality of projections extending in a tire width direction while protruding out of the tire inner surface are formed so as to be spaced in the tire circumferential direction, whereby the cross sectional shape of the cavity portion of the tire is changed in the tire circumferential direction, it is possible to effectively hold down the cavity resonance noise so as to reduce the road noise. In addition, since the projection is provided in the region which is inner in the tire width direction than the end portion of the belt layer, it is possible to achieve an excellent ride comfort performance without causing an increase of a vertical rigidity of the tire.

In the pneumatic tire in accordance with the present invention, it is preferable that a dense region in which the projections are arranged relatively densely, and a coarse region in which the projections are arranged relatively coarsely are provided alternately on a tire circumference, and the coarse region is arranged in a joint position of a rubber member constructing the tire.

Since the rigidity of the tread portion changes on the tire circumference, and the input from the road surface is fluctuated in correspondence thereto, by alternately providing the dense region and the coarse region of the projection as mentioned above on the tire circumference, it is possible to contribute to a reduction of the cavity resonance noise. In addition, since the coarse region is arranged at the joint position of the rubber member, it is possible to reduce a mass unbalance caused by the joint position so as to improve a uniformity of the tire.

In the pneumatic tire in accordance with the present invention, it is preferable that a distance or a phase in the tire circumferential direction of the projections is differentiated between an outer region and an inner region at a time of installing to a vehicle on the basis of a tire equator. In accordance with the structure mentioned above, it is possible to wholly hold down the cavity resonance so as to reduce the noise level, by differentiating the cycle of the vibration between the outer region and the inner region.

In the pneumatic tire in accordance with the present invention, it is preferable that a height of the projections from the inner surface of the tire is in a range between 2 and 8 mm. It becomes easy to secure the effect of reducing the cavity resonance noise by setting the height of the projection equal to or more than 2 mm, and it is possible to suitably prevent the rubber volume from coming short in the vicinity of the projection, by setting the height of the projection equal to or less than 8 mm.

Further, the present invention provides a method of manufacturing the any pneumatic tire mentioned above, wherein a bladder or a core in which a plurality of narrow grooves extending along the tire width direction are formed so as to be spaced in the tire circumferential direction is inserted to a green tire, the bladder or the core is pressed against an inner surface of the green tire at a time of vulcanization molding the green tire, and the projection is formed by a concave portion obtained by forming the narrow groove locally deeper and wider.

In accordance with the method of manufacturing the pneumatic tire mentioned above, since the projection as mentioned above can be formed in the tire inner surface by the normal vulcanization forming step, without going through any extra step, it is possible to manufacture the pneumatic tire in accordance with the present invention mentioned above without deteriorating a productivity.

### BRIEF DESCRIPTION OF THE DRAWINGS

FIG. 1 is a sectional view of a tire meridian showing one example of a pneumatic tire according to the present invention;

FIG. 2 is a perspective cross sectional view showing the pneumatic tire in FIG. 1;

FIG. 3(a) is a perspective view of a projection, and FIG. 3(b) is a cross sectional view along a line A-A;

FIG. 4 is a plan view schematically showing an inner surface of the tire;

FIG. 5 is a tire schematic side view for explaining a coarse and dense arrangement of the projections;

FIG. 6 is a schematic view of an inner surface of a tire in accordance with the other embodiment;

FIG. 7 is a schematic view of an inner surface of a tire in accordance with the other embodiment;

FIG. 8 is a schematic view showing a bladder which is used in a method of manufacturing the pneumatic tire in accordance with the present invention; and

FIG. 9 is a cross sectional view of a tire meridian and shows a modified example of the projection.

FIG. 10 is a perspective view of modified examples of the projection.

### DETAILED DESCRIPTION OF THE PREFERRED EMBODIMENTS

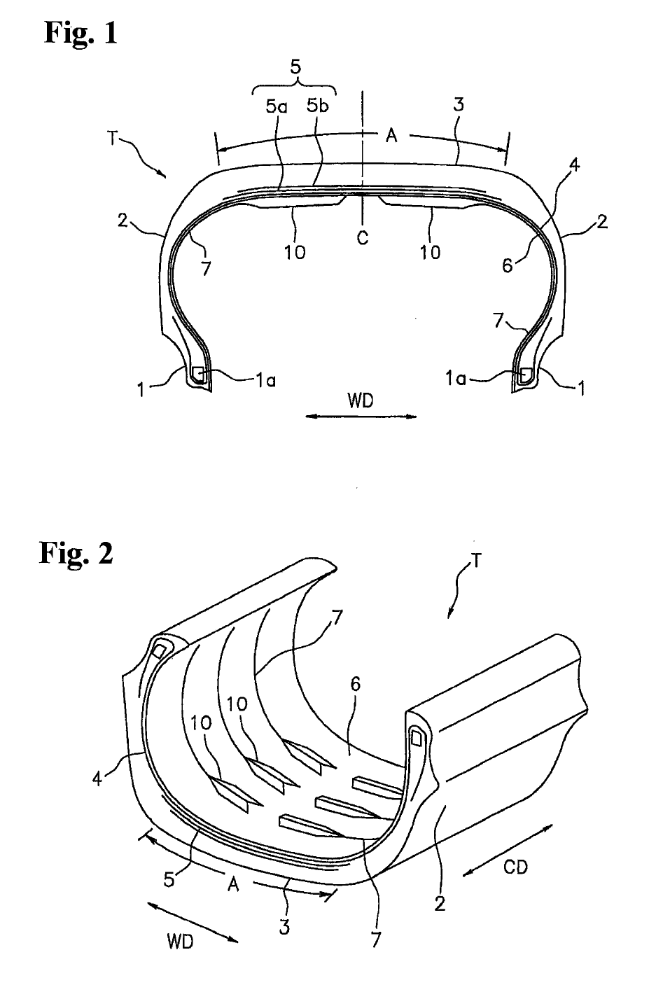

An embodiment of the present invention will be explained with reference to the drawings. A pneumatic tire T shown in FIG. 1 is provided with a pair of bead portions 1, side wall portions 2 extending to an outer side in a tire diametrical direction from the bead portions 1, and a tread portion 3 connecting the side wall portions 2 to each other. A tread surface coming to an outer surface of the tread portion 3 is provided with a block or a rib which is comparted by various grooves, and various tread patterns are formed in correspondence to a demanded tire performance and a used condition.

The tire T is a radial tire in which a toroidal carcass layer 4 is arranged between a pair of bead portions 1. The carcass layer 4 is constructed by a carcass ply including a cord extending in a radial direction, and an end portion thereof is folded back via a bead core 1a. A belt layer 5 constructed by belt plies 5a and 5b is arranged in an outer periphery of the carcass layer 4, and carries out a reinforcement on the basis of a hoop effect. Each of the belt plies 5a and 5b includes the cord which extends while being inclined with respect to a tire equator C, and is laminated in such a manner that the cords intersect inversely to each other between the plies.

A region A is a region which becomes inner in a tire width direction than end portions of the belt layer (end portions of a wide belt ply 5a) which is embedded in the tread portion 3. As shown in FIG. 2, in this tire T, a plurality of projections 10 extending in a tire width direction WD while protruding out of an inner surface of the tire are formed in the region A so as to be spaced in a tire circumferential direction CD. An inner liner rubber 6 is arranged in an inner periphery of the carcass layer 4 for holding a pneumatic pressure, and the projection 10 is formed by making the inner liner rubber 6 partially protrude.

In accordance with the structure mentioned above, a cross sectional shape of the cavity portion of the tire T is changed in the tire circumferential direction CD, and it is possible to effectively hold down the cavity resonance noise so as to reduce the road noise. Further, since the projection 10 is provided in the region A which becomes inner in the tire width direction than the end portions of the belt layer 5, and the projection 10 does not protrude to the outer side than the region A, it is possible to achieve an excellent ride comfort performance without causing an increase of the vertical rigidity of the tire T.

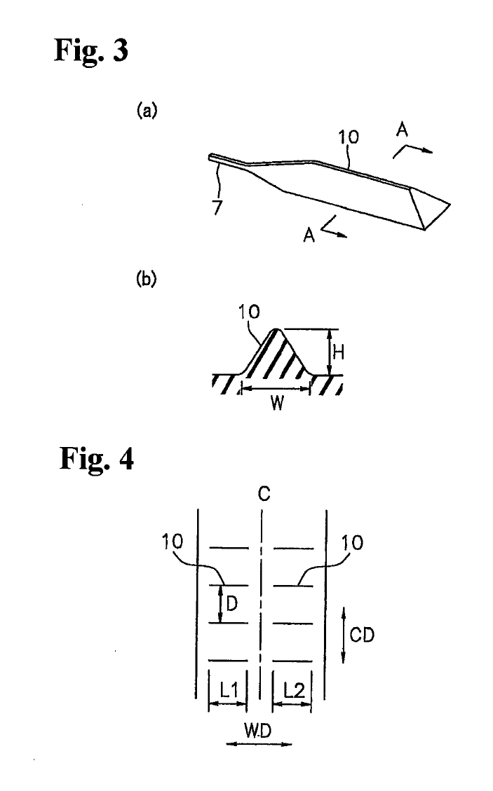

FIG. 3 is an enlarged view of the projection 10, and FIG. 3(a) shows a perspective view and FIG. 3(b) shows a cross sectional view along a line A-A. It is preferable that a height H of the projection 10 from the tire inner surface is in a range between 2 and 8 mm, whereby it is easy to secure an effect of reducing the cavity resonance noise, and it is possible to prevent a rubber volume from coming short in the periphery of the projection 10. In other words, in the case that the height H goes beyond 8 mm, the inner liner rubber 6 becomes thin in the periphery of the projection 10, and there is a tendency that the carcass layer 4 is apt to be exposed.

In order to make the projection 10 having the height as mentioned above effective, a width W of a portion of the projection 10 coming into contact with the tire inner surface is equal to or more than 2 mm, for example, between 4 and 10 mm. Further, in the light of suppressing a generation of a step defect, it is preferable that a corner portion formed by a side surface of the projection 10 and the tire inner surface is formed as a circular arc shape in accordance with a round process.

Stripe-like micro projections 7 are formed in the tire inner surface, however, since the height from the tire inner surface thereof is about 0.4 to 0.8 mm, they do not substantially contribute to the reduction of the road noise caused by the cavity resonance. As mentioned below, a narrow groove (a groove) serving as an air escape route is formed in a bladder which is pressed against the tire inner surface at a time of vulcanization forming, and the micro projections 7 are formed by a rubber entering into the narrow groove. In the present embodiment, projections 10 which are higher and wider than the micro projections 7 are provided along an extending direction of the micro projections 7.

FIG. 4 is a plan view schematically showing the inner surface of the tire T, and expresses the projection 10 by a segment passing through a center in a width direction of the projection 10. In the present embodiment, since each of the projections 10 extends in parallel to the tire width direction WD, it is possible to efficiently change the cross sectional shape of the cavity portion of the tire T. The extending direction of the projection 10 may be inclined at an angle ±30 degree with respect to the tire width direction WD.

In the light of moderately arranging the projections 10, an interval D of the projections 10 in the tire circumferential direction CD is, for example, between 10 and 30 mm. Because of the same reason, it is preferable that a rate of a total length (L1+L2 in the present embodiment) of the forming region of the projection 10 is between 60 and 90% with respect to the width of the belt layer 5 (the width of the wide belt ply 5a), in a state in which the tire is installed to a standard rim defined by JATMA, a normal internal pressure defined by JATMA is filled, and no load is applied.

If the rubber member constructing the tire T, for example, the rubber member constructing the tread, the side wall and the inner liner is formed by winding the rubber which is extruded with a final cross sectional shape or a cross sectional shape similar thereto, a thickness of the rubber member becomes comparatively large at a joint position coming to a joint between a leading end and a trailing end of the winding, and a uniformity of the tire tends to be deteriorated. Accordingly, it is desirable to arrange the joint positions so as to be dispersed at uniform intervals on the tire circumference.

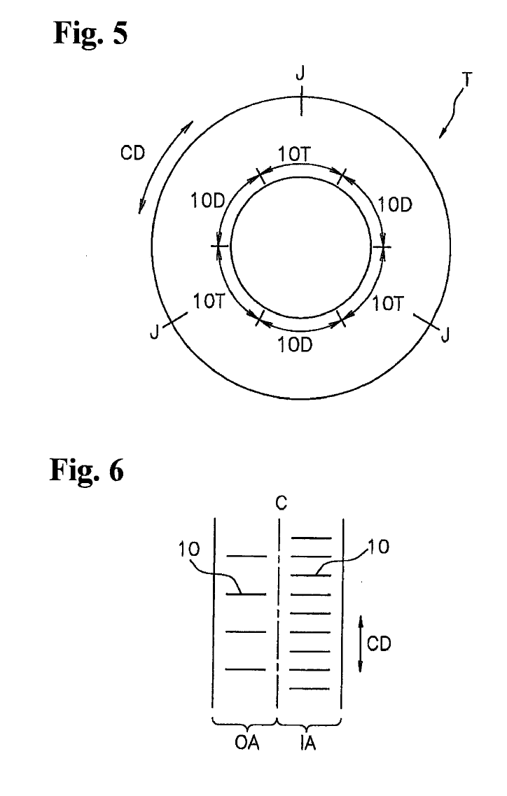

In the case mentioned above, as shown in FIG. 5, it is preferable to set a dense region 10D in which the projections 10 are arranged relatively densely, and a coarse region 10T in which the projections 10 are arranged relatively coarsely, alternately on the tire circumference, and arrange the coarse region 10T at the joint position J. Accordingly, it is possible to reduce a mass unbalance caused by the joint position J so as to further improve a uniformity of the tire T, and it is possible to contribute to the reduction of the cavity resonance noise. In this example, the tire inner surface which is divided into six sections uniformly in the tire circumferential direction CD is considered, and the dense region 10D and the coarse region 10T are defined in correspondence to the volume of the projections 10 arranged respectively therein.

In the case that a plurality of projections 10 have the same shape such as the present embodiment, the dense region 10D and the coarse region 10T can be set by regulating the interval D of the projection 10. In other words, it is possible to set the dense region 10D by making the interval D of the projections 10 relatively small, and set the coarse region 10T by making the interval D of the projections 10 relatively large. In this case, there is shown an example in which the interval D of the projections 10 is between 10 and 15 mm in the dense region 10D, and is between 15 and 30 mm in the coarse region 10T.

Of course, the rubber member constructing the tire T may be formed in accordance with a ribbon winding construction method. The ribbon winding construction method is a construction method of forming a rubber member having a desired cross sectional shape by winding an unvulcanized rubber ribbon having a small width and a small thickness at several times over.

FIG. 6 shows an example in which an interval in the tire circumferential direction CD of the projection 10 is differentiated between an outer region OA and an inner region IA at a time of installing the vehicle, on the basis of a tire equator C. Accordingly, it is possible to totally hold down the cavity resonance by differentiating the cycle of the vibration between the outer region OA and the inner region IA so as to reduce the noise level. Further, in the case that a volume difference is generated between the outer region OA and the inner region IA, by employing an asymmetric pattern in the tread portion 3, it is possible to improve the mass balance by making the interval of the projections 10 smaller in a side that the volume is smaller.

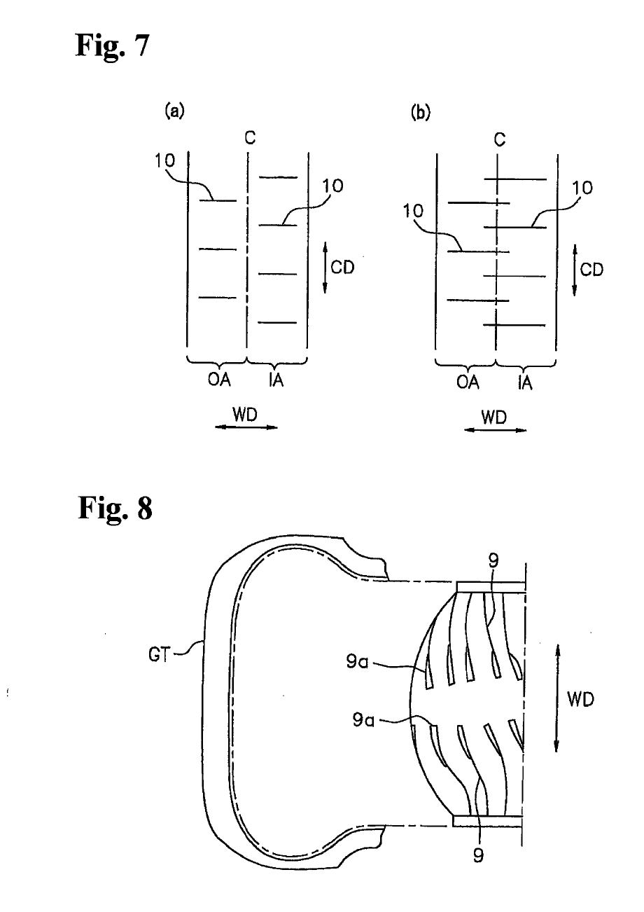

FIG. 7 shows an example in which a phase of the projection 10 in the tire circumferential direction CD is differentiated between the outer region OA and the inner region IA, and the projections are arranged in a staggered manner. Accordingly, it is possible to totally hold down the cavity resonance by differentiating the cycle of the vibration between the outer region OA and the inner region IA so as to reduce the noise level. Since it is possible to make a total length of the forming region of the projection 10 larger in the arrangement in FIG. 7(b) than in the arrangement in FIG. 7(a), it is possible to enhance the effect of suppressing the cavity resonance noise.

The pneumatic tire T can be manufactured via a vulcanization molding step using a bladder 8 which is a rubber bag as shown in FIG. 8. In the vulcanization molding step, a green tire GT is set to a tire mold, the bladder 8 is inserted to the green tire GT, and an outer surface of the inflated bladder 8 is pressed against an inner surface of the green tire GT at a time of vulcanization molding the green tire GT. A thickness of a rubber membrane of the bladder 8 is, for example, between 6 and 9 mm.

A plurality of narrow grooves 9 extending along the tire width direction WD are formed in an outer surface of the bladder 8 so as to be spaced in the tire circumferential direction. The narrow groove 9 plays a part in letting out an air between the outer surface of the bladder 8 and the tire inner surface. A concave portion 9a is formed by making the narrow groove 9 locally deeper and wider, and is provided at a position at which it is pressed against the tire inner surface in the region A. The concave portion 9a is formed as a corresponding shape to the projection 10, and is pressed against the inner surface of the tire, whereby the projection 10 is formed. Therefore, any extra step for forming the projection 10 is not demanded, and productivity is not deteriorated.

In the case of forming the tire in accordance with core vulcanization, the concave portion as mentioned above is provided in a core which takes the place of the bladder, and the projection is formed by the concave portion, at a time when an outer surface of the core is pressed against the inner surface of the green tire. The pneumatic tire in accordance with the present invention is not limited to the structure which is manufactured by the manufacturing method as mentioned above, but the projection in the inner surface of the tire may be formed in accordance with the other method.

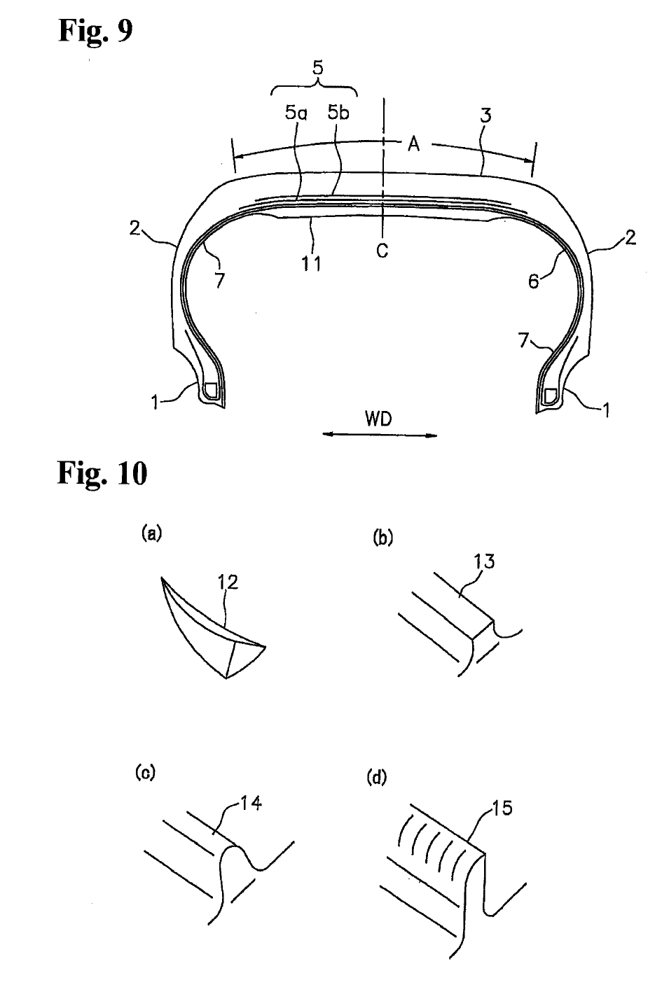

Modified examples of the projection are shown in FIGS. 9 and 10. Since a projection 11 shown in FIG. 9 extends continuously in the tire width direction WD, it is possible to enhance the effect of suppressing the cavity resonance noise by making the total length of the forming region of the projection large. In FIGS. 10(a) to 10(d), a projection in FIG. 10(a) is formed as a triangular shape in a cross section, a projection 13 in FIG. 10(b) is formed as a rectangular shape in a cross section, and a projection 14 in FIG. 10(c) is formed as a chevron shape in a cross section. A height is gradually decreased along an extending direction in the projection 12. On the contrary, since a height is constant in the projections 13 and 14, it is possible to enhance the effect of suppressing the cavity resonance noise. A projection 15 in FIG. 10(d) corresponds to a structure obtained by making the projection further longer than is wide and raising one side surface vertically, and the effect of suppressing the cavity resonance noise is further improved.

### EXAMPLES

An example tire which concretely shows the structure and effect of the present invention will be explained. An evaluation of each of performances is executed as follows.

(1) Cavity Resonance Noise Level

A test tire was installed to an actual car (a domestically built 3.5 L mini van vehicle) so as to be traveled, a sound pressure of a noise at a time of traveling at a speed 60 km/h was measured in accordance with JASO standard, and a noise in a frequency band 250 Hz was measured. An evaluation was carried out on the basis of an index number by setting a result of a comparative example 1 as 100, it indicates that the larger the numerical value is, the smaller the cavity resonance noise level is.

(2) Ride Comfort Performance

A test tire was installed to the actual car mentioned above so as to be traveled, and a point rating was carried out on a scale of one to ten in accordance with a subjective evaluation by a driver. It indicates that the larger the score is, the more excellent the ride comfort performance is.

(3) Uniformity

Based on a test method defined in JISD4233, RFV (radial force variation) was measured, and uniformity of a tire was evaluated. More specifically, a tire was pushed against a rotation drum such that a predetermined load is applied, and a variation amount of reaction force in a diametrical direction generated when the tire was rotated was measured while constantly maintaining a distance between both the shafts. An evaluation was carried out on the basis of an index number by setting a result of a comparative example 1 as 100, it indicates that the smaller the numerical value is, the more excellent the uniformity is.

(4) Molding Defect

In the number 100 to be evaluated, if the number of the defect (an internal galling (a cord exposure), a rubber short or the like) is within five in the vulcanization molding step, a mark ◯ is attached, and if it is equal to or more than six, a mark x is attached, in the evaluation.

### Comparative Examples 1 to 4

A tire in which a projection (except a stripe-like micro projection) is not formed in the inner surface of the tire was set to a comparative example 1. A tire in which a plurality of projections extending in a tire width direction are formed in the inner surface of the buttress portion so as to be spaced in the tire circumferential direction was set to a comparative example 2. A tire in which net-shaped projections are formed in the inner surface of the buttress portion in the same manner was set to a comparative example 3. A tire in which a plurality of projections extending while being inclined with respect to the tire diametrical direction are formed in the inner surface of the side wall portion so as to be spaced in the tire circumferential direction was set to a comparative example 4. In each of the examples, the height and the width of the projection was set to the same, and the tire size was set to 236/50R18. The projections in the comparative examples 2 to 4 were structured such that they are formed as a chevron shape in a cross section and a side surface and the tire inner surface are formed approximately vertical (without any round process).

### Examples 1 to 7

As shown in FIGS. 1 and 2, tires in which a plurality of projections extending in the tire width direction are formed in the inner surface in the region coming to the inner side in the tire width direction than the end portion of the belt layer so as to be spaced in the tire circumferential direction were set to examples 1 to 7. The conditions of the shape of the projection (FIGS. 10a to 10c), with or without right and left division (FIG. 1 and FIG. 9), the arrangement in the circumferential direction (with or without the coarse and dense arrangement as shown in FIG. 5), the arrangement in the width direction (FIGS. 4, 6 and 7) are as shown in Table 1. The height and the width of the projection in each of the examples were set to the same as those of the comparative example 2, and the tire size was set to 235/50R18.

TABLE 1

| | | compar- | compar- | compar- | compar- | | | | | | | | | | | | | | |
|---|---|---|---|---|---|---|---|---|---|---|---|---|---|---|---|---|---|---|---|
| | | ative | ative | ative | ative | exam- | | exam- | | exam- | | exam- | | exam- | | exam- | | exam- | |
| | | exam- | exam- | exam- | exam- | ple | | ple | | ple | | ple | | ple | | ple | | ple | |
| | | ple 1 | ple 2 | ple 3 | ple 4 | 1 | | 2 | | 3 | | 4 | | 5 | | 6 | | 7 | |
| aspect of | shape | — | FIG. 10c | FIG. 10c | FIG. 10c | FIG. | 10a | FIG. | 10a | FIG. | 10a | FIG. | 10a | FIG. | 10b | FIG. | 10b | FIG. | 10c |
| projection | right and left | — | — | — | — | FIG. | 9 | FIG. | 1 | FIG. | 1 | FIG. | 9 | FIG. | 1 | FIG. | 9 | FIG. | 9 |

| division | | | | | | | | | | | | | | |
|---|---|---|---|---|---|---|---|---|---|---|---|---|---|---|
| arrangement in | — | — | — | — | — | FIG. | 6 | FIG. | 7b | — | FIG. | 6 | — | — |

| | | | | | | | | | | | |
|---|---|---|---|---|---|---|---|---|---|---|---|
| width direction | | | | | | | | | | | |
| arrangement in | — | — | — | — | without | without | without | with | with | with | with |
| circumferential | | | | | coarse | coarse | coarse | coarse | coarse | coarse | coarse |
| direction | | | | | and | and | and | and | and | and | and |
| | | | | | dense | dense | dense | dense | dense | dense | dense |

| | | | | | | | | | | | |
|---|---|---|---|---|---|---|---|---|---|---|---|
| cavity resonance noise | 100 | 101 | 101 | 101 | 103 | 103 | 102 | 104 | 105 | 106 | 105 |
| level | | | | | | | | | | | |
| ride comfort performance | 6 | 5 | 5 | 5 | 6 | 6 | 6 | 6 | 6 | 6 | 6 |
| uniformity | 100 | 97 | 97 | 97 | 97 | 98 | 99 | 100 | 100 | 100 | 100 |
| molding defect | ∘ | x | x | x | ∘ | ∘ | ∘ | ∘ | ∘ | ∘ | ∘ |

From Table 1, it was known that in the examples 1 to 7, it is possible to reduce the road noise caused by the cavity resonance without deteriorating the ride comfort performance, in comparison with the comparative examples 1 to 4. In the examples 4 to 7 among them, the uniformity can be improved more than the examples 1 to 3, by employing the coarse and dense arrangement as shown in FIG. 5. In this case, the examples 4 to 7 are structured such that the coarse region of the projection is arranged at the joint position of the tread, the side wall and the inner liner.

What is claimed is:

1. A pneumatic tire wherein a plurality of projections extending in a tire width direction while protruding out of an inner surface of a tire are formed in a region coming to an inner side in a tire width direction than an end portion of a belt layer embedded in a tread portion so as to be spaced in a tire circumferential direction.

2. A pneumatic tire according to claim 1, wherein a dense region in which the projections are arranged relatively densely, and a coarse region in which the projections are arranged relatively coarsely are provided alternately on a tire circumference, and the coarse region is arranged in a joint position of a rubber member constructing the tire.

3. A pneumatic tire according to claim 1, wherein a distance or a phase in the tire circumferential direction of the projections is differentiated between an outer region and an inner region at a time of installing to a vehicle on the basis of a tire equator.

4. A pneumatic tire according to claim 1, wherein a height of the projections from the inner surface of the tire is in a range between 2 and 8 mm.

5. A method of manufacturing the pneumatic tire according to claim 1, wherein a bladder or a core in which a plurality of narrow grooves extending along the tire width direction are formed so as to be spaced in the tire circumferential direction is inserted to a green tire, the bladder or the core is pressed against an inner surface of the green tire at a time of vulcanization molding the green tire, and the projection is formed by a concave portion obtained by forming the narrow groove locally deeper and wider.
